(19) United States
(12) Patent Application Publication
(10) Pub. No.: US 2016/0290014 A1
(43) Pub. Date: Oct. 6, 2016

(54) A Luggage Fixing Lock

(71) Applicant: YIFENG MANUFACTURING CO.,LTD., Dongguan City, GD (CN)

(72) Inventor: Leo Lai, Dongguan City (CN)

(21) Appl. No.: 14/914,991

(22) PCT Filed: Apr. 27, 2015
(86) PCT No.: PCT/CN2015/077530

§ 371 Date: Feb. 26, 2016

(30) Foreign Application Priority Data
Aug. 29, 2014 (CN) 201420493802.6

(51) Int. Cl. E05B 65/52; E05B 37/00; E05B 37/08

(52) U.S. Cl. CPC E05B 65/52; E05B 37/08; E05B 37/0031

(57) ABSTRACT

A luggage fixing lock comprises a shell fixed to a luggage, wherein the shell is provided with a lock body, the lock body is provided with a switch element for controlling the luggage body to be opened or closed. The luggage fixing lock also comprises a locking mechanism for locking a cover board, and the switch element is in linked connection with the locking mechanism. When the lock body is unlocked, the switch element can drive the locking mechanism to be unlocked, and one end of the cover board can be separated from the luggage body. When the lock body is locked, the switch element is limited. The luggage fixing lock is simple in structure, the luggage body and the cover board can be controlled at the same time, and use is convenient.

### FIELD OF THE INVENTION

The present disclosure belongs to the technical field of the mechanical lock, in particular, relates to a luggage fixing lock.

### BACKGROUND OF THE INVENTION

With the development of society, luggage has become a necessity of life. Different types of luggage will be carried with when people traveling abroad, go traveling or go to school. Because of the popularity of notebook computers currently, lots of people going out with a notebook computer. For portability, there are luggage that can lock notebook computers entering the market, that is a cover board was provided on one side of the luggage, forming a receiving space between the luggage body and the cover board for locking a notebook computer. There are several forms to lock a luggage body and a cover board: 1. setting up a separate lock on one side of the cover board, although this scheme solves the problem of lock a notebook computer, meanwhile leads to complex luggage structures. 2. integrating a lock for a notebook computer into the lock for a luggage. However, integrated fixing lock in prior art are integrated formally, both structure and function are separated and independent. So it is need to develop integrated fixing locks with reasonable structures.

### SUMMARY OF THE INVENTION

The aim of the present disclosure is to solve the problems of existing technology, providing a luggage fixing lock with simple structure. Therefore a lock for a notebook computer can be easily controlled by said luggage fixing lock.

In order to achieve the above purposes, the technical scheme of the present disclosure is illustrated as followed.

A luggage fixing lock, comprising:

a shell provided with a lock body fixed to a luggage, said lock body is provided with a switch element for controlling the luggage body to be opened or closed; and
a locking mechanism, used for locking a cover board;
the switch element is in linked connection with the locking mechanism;
when the lock body is unlocked, said switch element can drive said locking mechanism to be unlocked, and one end of the cover board can be separated from the luggage body;
when the lock body is locked, said switch element is limited.

Further, the bottom of the shell is provided with a through hole, said switch element is provided with a driving part which is in linked connection with the locking mechanism, said driving part extends out of the through hole; said locking mechanism comprises a lock cover hook for controlling the opening or closure of said cover board, a poke rod for driving the movement of said lock cover hook;

said lock cover hook comprises a hook part and a controlled part, one end of said poke rod is in linked connection with the controlled part of said lock cover hook, the other end is in linked connection with the driving part of said switch element.

Further, said luggage fixing lock comprises a latch hook component, said switch element is connected with said latch hook component, said switch element is in linked connection with the lock body;

while unlocking said lock body, a push block drives said switch element to move, and then realizing unlocking the luggage body or the cover board;
while locking the cipher lock device, said switch element is limited.

Further, said lock body comprises a tumbler lock, said tumbler lock comprises a key cylinder,

a sliding hole is provided on one side of said shell, said sliding hole is provided with a sliding push block, the middle part of said push block is provided with a mounting hole for installing the key cylinder, said key cylinder is arranged in said mounting hole,
the lower end of said key cylinder is connected with a rotating block for driving the switch element to move, said rotating block is connected with said switch element.

Further, said lock body comprises a locking sleeve and a cipher lock device;

said locking sleeve is connected with the lower end of said push block and sets out of said key cylinder;
said cipher lock device comprises a cipher wheel and a wheel shaft, said cipher wheel is set out of said wheel shaft, the shell is provided with a gap for said cipher wheel exposed out, one end of said wheel shaft is connected or contacted with said locking sleeve;

while said cipher lock device being unlocked, said wheel shaft can move relative to said cipher wheel; while said cipher lock device being locked, said wheel shaft is limited.

Further, said cipher lock device comprises coding wheels, a return spring and coding switches,

said coding wheels are provided between the cipher wheel and the wheel shaft, said cipher wheel is set out of the wheel shaft through said coding wheels,
said return spring is set out of the end near said locking sleeve of said wheel shaft,
said coding switch comprises a coding block and a switch block,
said wheel shaft is provided with a shaft trough arranged along the axial direction and a plurality of ring grooves radially,
the shaft hole of said coding wheels is matched with the wheel shaft, and said shaft hole is provided with bumps matched with said ring grooves,
said coding block is provided with a socket hole, said coding block is sleeve-connected with one end of said wheel shaft which away from said locking sleeve, and said coding block can move relative to said wheel shaft,
said switch block is provided with a angular surface for pushing said coding block, said switch block also comprises executing bumps, said shell is provided with coding holes matched with said executing bumps, and said executing bumps protrude out of said shell.

Further, said latch hook component comprises a base plate, a latch hook,

a lock block and a torsion spring,
said latch hook is provided with two rotating shafts on both sides, respectively,
base blocks are provided on the upper end of said base plate, which matched with said rotating shafts, said rotating shafts are connected to said base blocks, said torsion spring is sleeve-connected with said rotating shafts, said base plate is provided with a accommodation hole on the bottom surface for receiving said lock block, said lock block is arranged inside said accommodation hole, said latch hook is provided with a hook part on one end, and a limiting part on the other end,
said base plate is provided with an opening on the up surface for said limiting part rotating through, said lock block is provided with a bayonet matched with said limiting part, said lock block is provided with a controlled part on the lower end, said controlled part is in linked connection with one end of said switch element.

While being locked, the bayonet of said lock block and the limiting part of said latch hook are staggered, the limiting part of said latch hook is contacted with said lock block, the hook part is in a locked state. While being unlocking, movement of said switch element drives said controlled part to move. After said lock block is moved, the limiting part of said latch hook and said bayonet are corresponded, said latch hook rotates under the action of said torsion spring, said limiting part rotates to said bayonet, the hook part is unlocked.

Further, said accommodation hole is provided with a return spring inside for resetting said lock block, said switch element is provided with a angular surface for pushing the controlled part of said lock block.

Further, said base plate is provided with an extension block extended in the direction of the coding switches, said switch block is provided with a positioning column in the lower part, said extension block is provided with a positioning hole matched with said positioning column.

Further, wherein said switch element is provided with a notch at the end near said rotating block, a push pedal is provided inside said notch, the lower end of said rotating block is provided with two poke blocks, said switch element and said push pedal are provided with notches matched with said poke blocks, said poke blocks are inserted into said notches.

Further, said shell comprises a face shell and a bottom shell, said face shell and said bottom shell are fixed connected, said bottom shell is provided with a bottom plate on the bottom surface, said bottom plate is provided with a mounting portion in the lower end, said mounting portion connected to the lock seat through the installation gap.

Further, beneath said cipher wheel is provided with shell fragments (not shown), said shell fragments comprise fixed part and multiple elastic parts matched with said cipher wheel, said fixed part is fixed in the shell, said elastic parts are contacted with said cipher wheel.

The present disclosure has achieved beneficial effects such as: with a simple structure, the luggage body and the cover board can be controlled at the same time, and use is convenient.

### BRIEF DESCRIPTION OF THE DRAWINGS

FIG. 1 illustrates a schematic view of the utility mode in use.

FIG. 2 illustrates another schematic view of the utility mode in FIG. 1.

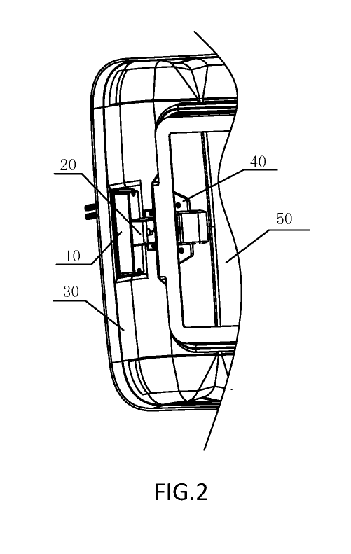

FIG. 3 illustrates a decomposition structure of the utility mode.

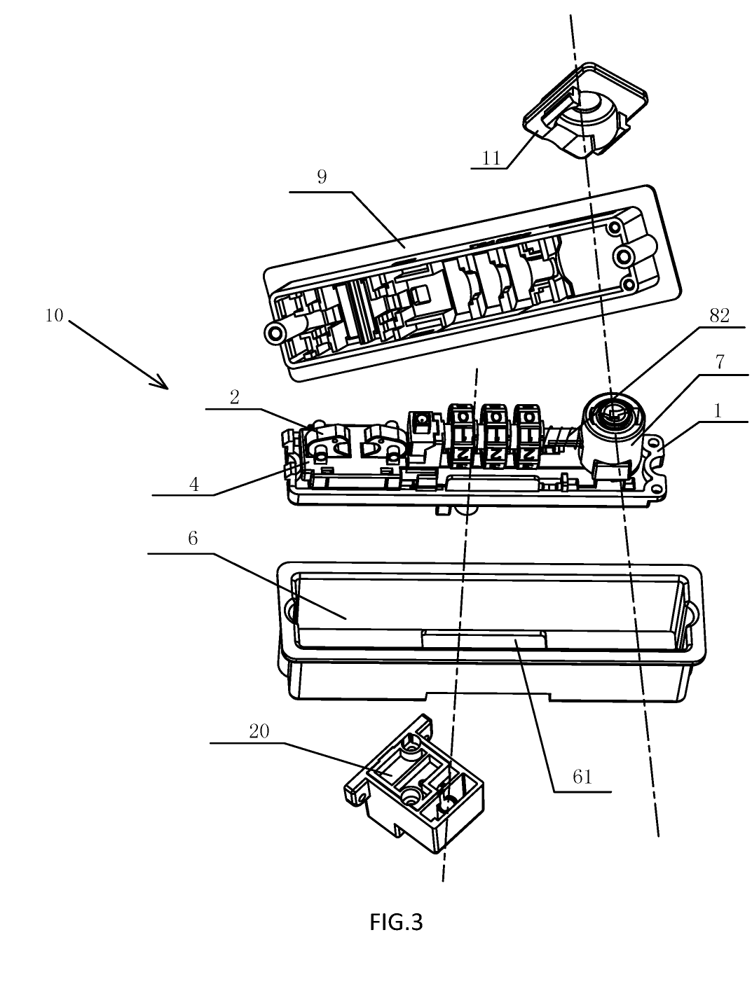

FIG. 4 illustrates another decomposition structure of the utility mode.

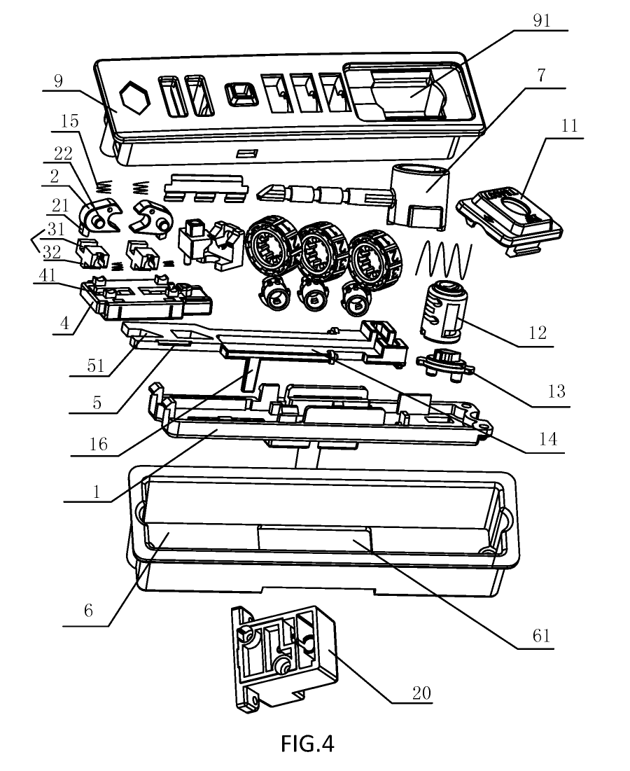

FIG. 5 illustrates a decomposition structure of the cipher lock device.

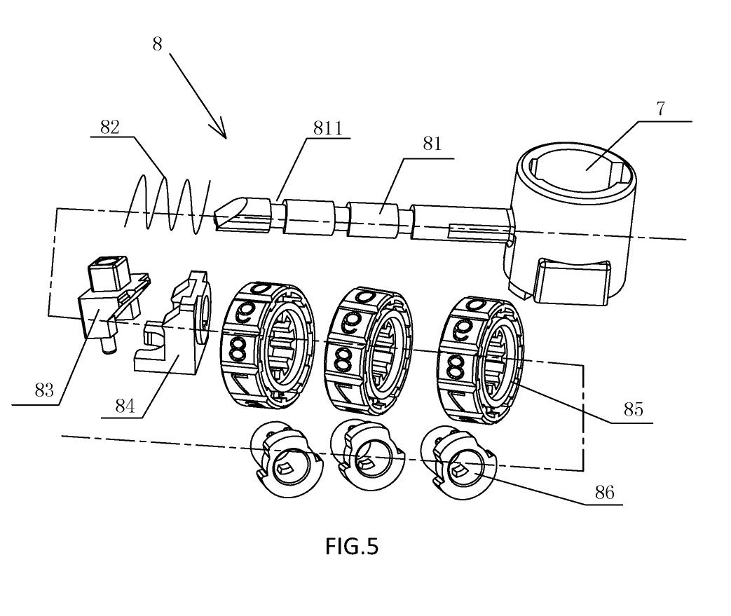

FIG. 6 illustrates a schematic view of the press block.

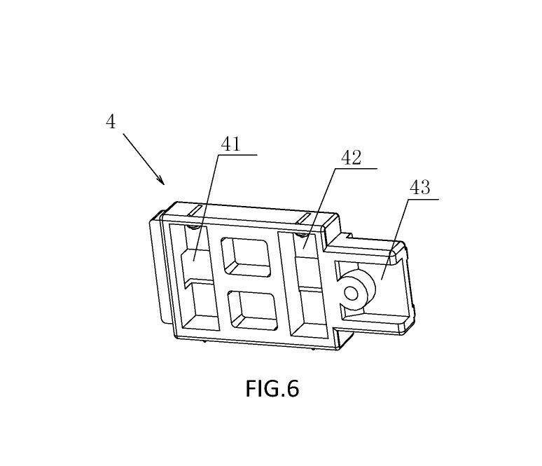

FIG. 7 illustrates a schematic view of the utility mode.

FIG. 8 illustrates a sketch of assembling of the cover buckle when the utility mode in use.

FIG. 9 illustrates a schematic view of the locking mechanism.

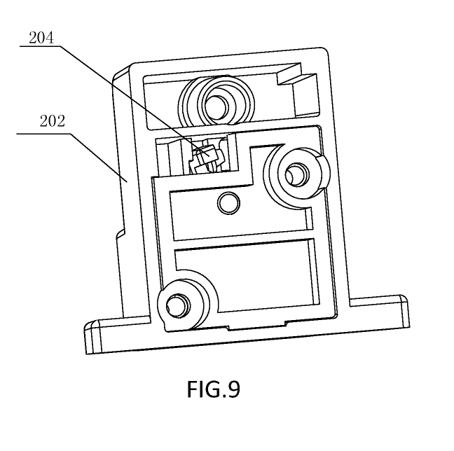

FIG. 10 illustrates a decomposition structure of FIG. 9.

### DRAWING SIGNS

1—bottom plate—2 latch hook 3—lock block 4—base plate 5—switch element 6—bottom shell 7—locking sleeve 8—cipher lock device 9—face shell 10—luggage fixing lock 11—push block 12—key cylinder 13—rotating block 14—push pedal 21—limiting part 22—rotating shaft 31—bayonet 32—controlled part 41—opening 42—accommodation hole 43—extension block 51—angular surface 61—installation gap 81—wheel shaft 82—return spring 83—switch block 84—coding block 85—cipher wheel 86—coding wheel 811—ring groove 812—shaft trough 91—through hole 15—torsion spring 20—locking mechanism 30—shell 50—cover board 202—lock seat 203—lock cover hook 204—poke rod 16—driving part 40—cover buckle 205—torsion spring 206—pin shaft 201—pinch plate

### DESCRIPTION OF THE PREFERRED EMBODIMENTS

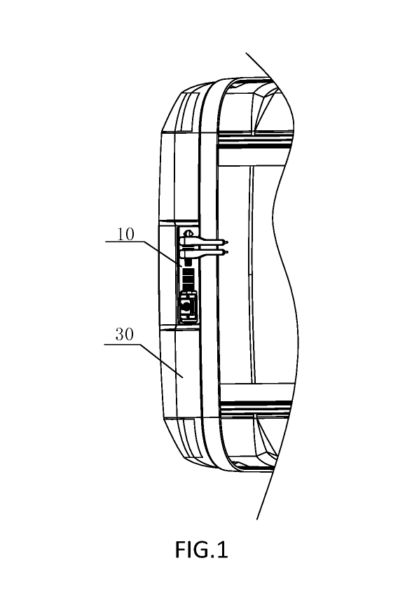

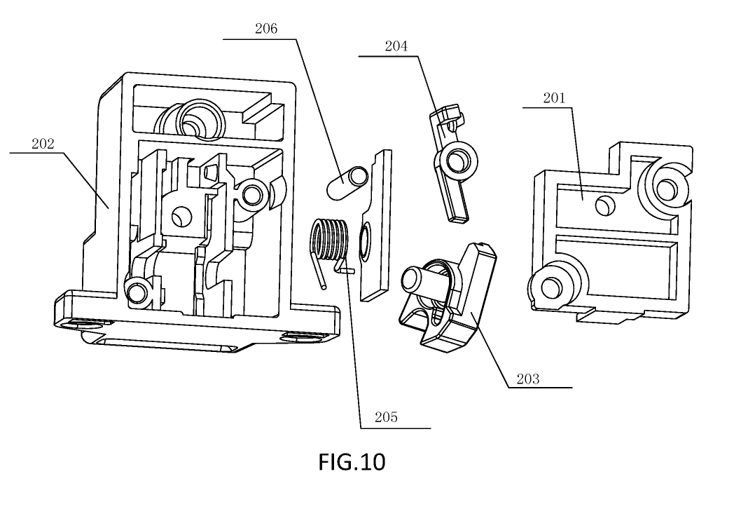

Detailed description of the utility model will become apparent from the following further description made with reference to the accompanying drawings FIG. 1—FIG. 10 and the preferred embodiment.

### Embodiment

Reference to the accompanying drawings FIG. 1—FIG. 10.

A luggage fixing lock 10, comprising: —a shell fixed to a luggage, wherein the shell is provided with a lock body, the lock body is provided with a switch element 5 used for controlling the luggage body to be opened or closed; and —a locking mechanism 20, used for locking a cover board 50;

the switch element 5 is in linked connection with the locking mechanism 20; when the lock body is unlocked, the switch element 5 can drive the locking mechanism 20 to be unlocked, and one end of the cover board 50 can be separated from the luggage body; when the lock body is locked, the switch element 5 is limited.

While the technical scheme is implemented, coordinated with a normally used lock body, the switch element 5 controls the opening or closure of a luggage, meanwhile controls the opening or closure of the cover board 50, as well. Namely, the switch element 5 controls the opening or closure of the luggage and the cover board 50, both. A luggage usually comprises an up luggage body and a bottom luggage body, while the cover board 50 is provided on the side surface of the bottom luggage body. The lock body is provided on the bottom luggage body, the opening or closure of the bottom luggage body between the up luggage body, the cover board 50 can be achieved at the same time.

Further, the bottom of the shell is provided with a through hole, said switch element 5 is provided with a driving part 16, said driving part 16 extends out of the through hole. Said locking mechanism 20 comprises a lock cover hook 203 for controlling the opening or closure of said cover board 50, a poke rod 204 for driving the movement of said lock cover hook 203. Wherein, said lock cover hook 203 comprises a hook part and a controlled part, one end of said poke rod 204 is in linked connection with the controlled part of said lock cover hook 203, the other end is in linked connection with the driving part 16 of said switch element 5.

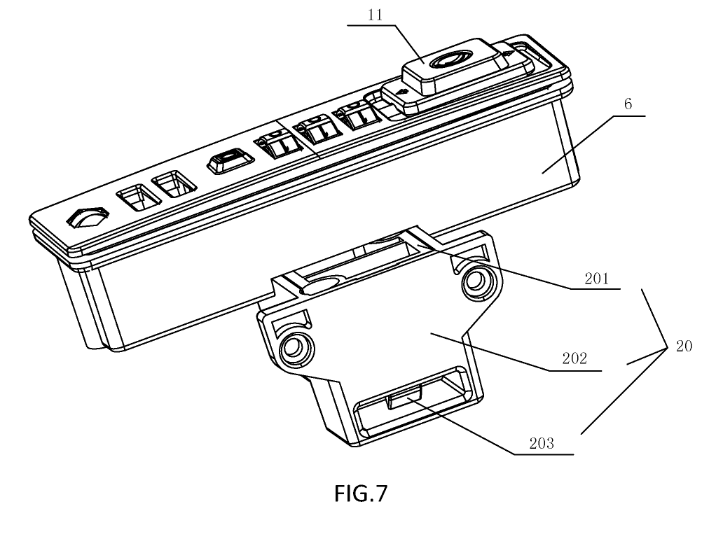

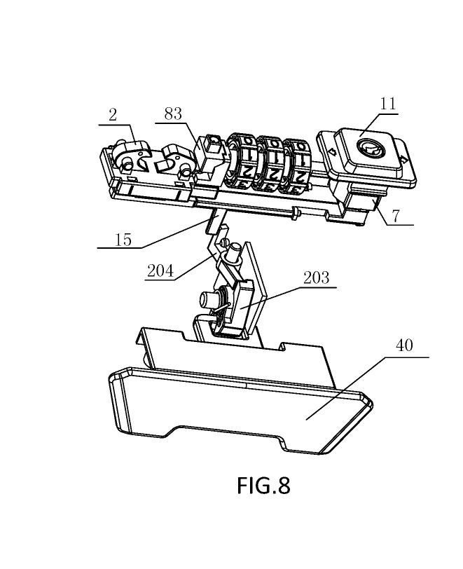

There are many types of lock bodies currently, such as tumbler lock, cipher lock. A key is used to unlock the lock body in a tumbler lock, rotation of the key drives the movement of said switch element 5. In this case, said switch element 5 could be an eccentric block connected with a key cylinder 12. While said key cylinder 12 rotates, said eccentric block rotates at the same time, rotation of said eccentric block toggles the other end of said poke rod 204 to move, then said poke rod 204 pushes said lock cover hook 203 moving, so as to realize the opening or closure of said cover board 50. In a cipher lock, said switch element 5 could be a lock latch for said cipher lock. While in unlocking position, said lock latch toggles the other end of said poke rod 204 to move, realizing opening or closure of said cover board 50. While said lock latch in locked position, both said poke rod 204 and said lock cover hook 203 keep said cover board 50 in locked state. Reference to FIG. 8, said locking mechanism 20 is provided with a lock seat 202 and a pinch plate 201, said lock cover hook 203 is hinged in said lock seat 202 through a torsion spring 205, said lock seat 202 is provided with a inserted through hole for a cover buckle 40 (FIG. 7). Said poke rod 204 is hinged in said lock seat 202 through a pin shaft 206, one end of said poke rod 204 is contacted with the controlled part of said lock cover hook 203, while the other end is offset or contacted with the driving part 16 of said switch element 5.

While the driving part 16 of said switch element 5 leaves said poke rod 204, said lock cover hook 203 flips under the action of the torsion spring 205, said cover board 50 could be opened. The locking mechanism could be a latch hook simply, by changing of movements or positions of the latch hook, controlling opening or closure of said cover board 50.

Further, said luggage fixing lock 10 comprises a latch hook component, said switch element 5 is connected with said latch hook component. Said switch element 5 is in linked connection with the lock body. While unlocking said lock body, a push block 11 drives said switch element 5 to move, and then realizing unlocking the luggage body or the cover board. While locking the cipher lock device, said switch element 5 is limited.

The latch hook component could be a latch hook component descried in patent CN201320508516.8, wherein said switch element 5 is equivalent to the button.

Further, said lock body comprises a tumbler lock, said tumbler lock comprises a key cylinder 12, the lower end of the key cylinder 12 is connected with a rotating block 13 for driving the switch element 5 to move, said rotating block 13 is connected with said switch element 5.

Said switch element 5 can be driven to move through a generally used key, it is simple and convenient.

Further, said lock body comprises a locking sleeve 7 and a cipher lock device 8, a sliding hole is provided on one side of said shell, said sliding hole is provided with a sliding push block 11, the middle part of said push block 11 is provided with a mounting hole for installing the key cylinder 12, said key cylinder 12 is arranged in said mounting hole, said locking sleeve 7 is connected with the lower end of said push block 11 and sets out of said key cylinder 12. Said cipher lock device 8 comprises a cipher wheel and a wheel shaft, said cipher wheel is set out of said wheel shaft, the shell is provided with a gap for said cipher wheel exposed out, one end of said wheel shaft is connected or contacted with said locking sleeve 7. While said cipher lock device 8 being unlocked, said wheel shaft can move relative to said cipher wheel. While said cipher lock device 8 being locked, said wheel shaft is limited.

In addition to a key lock, a cipher lock is added, as well. While unlocked the cipher lock, said push block 11 can drive the switch element 5 to move, so as to realize locking or unlocking.

Further, said cipher lock device 8 comprises coding wheels 86, a return spring 82 and coding switches, said coding wheels 86 are provided between the cipher wheel 85 and the wheel shaft 81, said cipher wheel 85 is set out of the wheel shaft 81 through said coding wheels 86. Said return spring 82 is set out of the end near said locking sleeve 7 of said wheel shaft 81, said coding switch comprises a coding block 84 and a switch block 83, said wheel shaft 81 is provided with a shaft trough 812 arranged along the axial direction and a plurality of ring grooves 811 radially. The shaft hole of said coding wheels 86 is matched with the wheel shaft 81, and said shaft hole is provided with bumps matched with said ring grooves 811. Said coding block 84 is provided with a socket hole, said coding block 84 is sleeve-connected with one end of said wheel shaft 81 which away from said locking sleeve 7, and said coding block 84 can move relative to said wheel shaft 81. Said switch block 83 is provided with a angular surface 51 for pushing said coding block 84, said switch block 83 also comprises executing bumps, said shell is provided with coding holes matched with said executing bumps, and said executing bumps protrudes out of said shell.

Coding wheels 86, said return spring 82 and said coding switches are provided to realize coding of said cipher lock device 8. While being coded, the cipher wheel 85 is toggled to the right position, then press the executing bumps, said switch block 83 squeezes said coding block 84, said coding block 84 moves and contacted with said coding wheels 86. Meanwhile, the bumps of said coding wheels 86 are located at the overlap between the shaft trough 812 and the ring groove 811, said coding wheels 86 moves relative to said wheel shaft 81. Said cipher wheel 85 slides from one end of said coding wheels 86 to the other end, meanwhile said cipher wheel 85 and said coding wheels 86 are separated, said cipher wheel 85 can rotate relative to said coding wheels 86, said coding wheels 86 compresses said return spring 82. Then the position of said cipher wheel 85 can be adjusted, so as to reset the password. After that, release the executing bumps, said return spring 82 is reset, which drives said coding wheels 86 and said coding block 84 to reset.

Further, said latch hook component comprises a base plate 4, a latch hook 2, a lock block 3 and a torsion spring 15. Said latch hook 2 is provided with a rotating shaft 22 on both sides, respectively. Base blocks are provided on the upper end of said base plate 4, which is matched with said rotating shafts 22. Said rotating shafts 22 is connected to said base blocks, said torsion spring 15 is sleeve-connected with said rotating shafts 22, said base plate 4 is provided with a accommodation hole 42 on the bottom surface for receiving said lock block 3, said lock block 3 is arranged inside said accommodation hole 42. Said latch hook 2 is provided with a hook part on one end, and a limiting part 21 on the other end. Said base plate 4 is provided with an opening 41 on the up surface for said limiting part 21 rotating through. Said lock block 3 is provided with a bayonet 31 matched with said limiting part 21, said lock block 3 is provided with a controlled part 32 on the lower end, said controlled part 32 is in linked connection with one end of said switch element 5. While being locked, the bayonet 31 of said lock block 3 and the limiting part 21 of said latch hook 2 are staggered, the limiting part 21 of said latch hook 2 is contacted with said lock block 3, the hook part is in a locked state. While being unlocking, movement of said switch element 5 drives said controlled part 32 to move. After said lock block 3 is moved, the limiting part 21 of said latch hook 2 and said bayonet 31 are corresponded, said latch hook 2 rotates under the action of said torsion spring 15, said limiting part 21 rotates to said bayonet 31, the hook part is unlocked.

In this embodiment, the hook part is U-shaped, then a question mark shape will also be allowed. While in locked status, the hook part is in a horizontal state, which is consistent with the direction of the hook part and the length direction of the luggage fixing lock 10. While in unlocked status, the hook part is in a vertical state. The movement of said latch hook component is controlled by said switch element 5. While being locked, the limiting part 21 of said latch hook 2 is contacted with said lock block 3 through the opening 41 in said base plate 4 under the rotating force of said torsion spring 15, then said limiting part 21 and said bayonet 31 are staggered, the hook part is in a locked state. While being unlocking, movement of said switch element 5 drives the controlled part 32 of said lock block 3 to move. After said lock block 3 is moved, the limiting part 21 and said bayonet 31 are corresponded, the limiting part 21 of said latch hook 2 moves to said bayonet 31, said latch hook 2 is unlocked. In this embodiment, the reset of said latch hook 2 can be realized by setting a reset part, or driving said switch element 5 to reset said lock block 3.

Further, said accommodation hole 42 is provided with a return spring 82 inside for resetting said lock block 3, said switch element 5 is provided with a angular surface 51 for pushing the controlled part 32 of said lock block 3.

While in utilization, said return spring 82 assistants said lock block 3 to reset. Said switch element 5 is matched with said lock block 3 through said angular surface 51, while being unlocked, said switch element 5 against said lock block 3 through said angular surface 51, and said lock block 3 is pushed to move by said switch element 5. Then said lock block 3 moves to said bayonet 31 corresponding to the limiting part 21 of said latch hook 2, and said latch hook 2 flips open under the action of said torsion spring 15. While being locked, said switch element 5 is reset, said latch hook 2 is reset under the action of fastener pieces, then said lock block 3 is reset under the action of said return spring 82.

Further, said base plate 4 is provided with an extension block 43 extended in the direction of the coding switches. Said switch block 83 is provided with a positioning column in the lower part, said extension block 43 is provided with a positioning hole matched with said positioning column.

The positioning column and the positioning hole are provided to assist the directional movement of said switch block 83, avoiding said switch block 83 deviates form moving position.

Further, said switch element 5 is provided with a notch at the end near said rotating block 13, a push pedal 14 is provided in said notch, the lower end of said rotating block 13 is provided with two poke blocks, said switch element 5 and said push pedal 14 are provided with notches matched with said poke blocks, said poke blocks are inserted into said notches.

Said push pedal 14 is assisted to push said switch element 5. For in a key lock, the rotation direction is fixed, positive rotation unlocks the lock, while reverse rotation is not allowed.

Further, said shell comprises a face shell 9 and a bottom shell 6, said face shell 9 and said bottom shell 6 are connected fixed, said bottom shell 6 is provided with a bottom plate 1 on the bottom surface.

Further, the lower end of said cipher wheel 85 is provided with shell fragments (not shown), said shell fragments comprise fixed part and multiple elastic parts matched with said cipher wheel 85, said fixed part is fixed in the shell, said elastic parts are contacted with said cipher wheel 85.

While in rotation, the abutment of said cipher wheel 85 and said elastic parts produces a certain resistance, said shell fragments are provided to promote the toggling feel, making the rotational speed much easy to control.

The above is only the preferred embodiment of the application, on the basis of the same technical scheme is still falling into the scope of application for protection.

What is claimed is:

1. A luggage fixing lock, comprising:
a shell provided with a lock body fixed to a luggage, said lock body is provided with a switch element for controlling the luggage body to be opened or closed; and
a locking mechanism, used for locking a cover board;
the switch element is in linked connection with the locking mechanism;
when the lock body is unlocked, said switch element can drive said locking mechanism to be unlocked, and one end of the cover board can be separated from the luggage body;
when the lock body is locked, said switch element is limited.

2. The luggage fixing lock of claim 1, wherein the bottom of the shell is provided with a through hole, said switch element is provided with a driving part which is in linked connection with the locking mechanism, said driving part extends out of the through hole;
said locking mechanism comprises a lock cover hook for controlling the opening or closure of said cover board, a poke rod for driving the movement of said lock cover hook;
said lock cover hook comprises a hook part and a controlled part, one end of said poke rod is in linked connection with the controlled part of said lock cover hook, the other end is in linked connection with the driving part of said switch element.

3. The luggage fixing lock of claim 2, wherein said luggage fixing lock comprises a latch hook component, said switch element is connected with said latch hook component, said switch element is in linked connection with the lock body;
while unlocking said lock body, a push block drives said switch element to move, and then realizing unlocking the luggage body or the cover board;
while locking the cipher lock device, said switch element is limited.

4. The luggage fixing lock of claim 3, wherein
said lock body comprises a tumbler lock, said tumbler lock comprises a key cylinder, a sliding hole is provided on one side of said shell, said sliding hole is provided with a sliding push block, the middle part of said push block is provided with a mounting hole for installing the key cylinder, said key cylinder is arranged inside said mounting hole, the lower end of said key cylinder is connected with a rotating block for driving the switch element to move, said rotating block is connected with said switch element.

5. The luggage fixing lock of claim 4, wherein said lock body comprises a locking sleeve and a cipher lock device;
said locking sleeve is connected with the lower end of said push block and sets out of said key cylinder;
said cipher lock device comprises a cipher wheel and a wheel shaft, said cipher wheel is set out of said wheel shaft, the shell is provided with a gap for said cipher wheel exposed out, one end of said wheel shaft is connected or contacted with said locking sleeve;
while said cipher lock device being unlocked, said wheel shaft can move relative to said cipher wheel, while said cipher lock device being locked, said wheel shaft is limited.

6. The luggage fixing lock of claim 5, wherein said cipher lock device comprises coding wheels, a return spring and coding switches,
said coding wheels are provided between the cipher wheel and the wheel shaft, said cipher wheel is set out of the wheel shaft through said coding wheels,
said return spring is set out of the end near said locking sleeve of said wheel shaft,
said coding switch comprises a coding block and a switch block,
said wheel shaft is provided with a shaft trough arranged along the axial direction and a plurality of ring grooves radially,
the shaft hole of said coding wheels is matched with the wheel shaft, and said shaft hole is provided with bumps matched with said ring grooves,
said coding block is provided with a socket hole, said coding block is sleeve-connected with the end away from said locking sleeve of said wheel shaft, and said coding block can move relative to said wheel shaft,
said switch block is provided with a angular surface for pushing said coding block, said switch block also comprises executing bumps, said shell is provided with coding holes matched with said executing bumps, and said executing bumps protrude out of said shell.

7. The luggage fixing lock of claim 6, wherein said latch hook component comprises a base plate, a latch hook, a lock block and a torsion spring,
said latch hook is provided with a rotating shaft on both sides, respectively;
base blocks are provided on the upper end of said base plate, which matched with said rotating shafts, said rotating shafts are connected to said base blocks, said torsion spring is sleeve-connected with said rotating shafts, said base plate is provided with a accommodation hole on the bottom surface for receiving said lock block, said lock block is arranged inside said accommodation hole, said latch hook is provided with a hook part on one end, and a limiting part on the other end, said base plate is provided with an opening on the up surface for said limiting part rotating through, said lock block is provided with a bayonet matched with said limiting part, said lock block is provided with a controlled part on the lower end, said controlled part is in linked connection with one end of said switch element.

8. The luggage fixing lock of claim 7, wherein said accommodation hole is provided with a return spring inside for resetting said lock block, said switch element is provided with a angular surface for pushing the controlled part of said lock block.

9. The luggage fixing lock of claim 8, wherein said base plate is provided with an extension block extended in the direction of the coding switches, said switch block is provided with a positioning column in the lower part, said extension block is provided with a positioning hole matched with said positioning column.

10. The luggage fixing lock of claim 9, wherein said switch element is provided with a notch at the end near said rotating block, a push pedal is provided inside said notch, the lower end of said rotating block is provided with two poke blocks, said switch element and said push pedal are provided with notches matched with said poke blocks, said poke blocks are inserted into said notches.
